(19) United States
(12) Patent Application Publication
(10) Pub. No.: US 2009/0133286 A1
(43) Pub. Date: May 28, 2009

(54) METHOD AND MACHINE FOR PRE-DRYING STAMP-PRINTS

(76) Inventor: DAVID VALLEJO, Medellin (CO)

Correspondence Address: JOHN J. MARTINEZ MD. JD., 10 PALMER AVENUE, CROTON ON HUDSON, NY, 10520, US

(21) Appl. No.: 11/944,640

(22) Filed: Nov. 26, 2007

(51) Int. Cl. F26B 13/00; B62B 5/00; F26B 13/10

(52) U.S. Cl. 34/618; 280/638; 34/622

(57) ABSTRACT

The present invention provides an apparatus or machine to pre-dry fabric prints, wherein said machine comprises: A) a moving heat source that moves along a fixed long straight arm; B) a motor that powers the moving heat source by means of a belt; C) a control unit that commands the motor; and D) a stand for the fixed long arm with the heat source, and for the motor; wherein the heat source moves momentarily forth from a zero position along the long straight arm to a position on the top of a fabric that have been printed with a layer of fabric dye, and then the heat source moves back to the zero position.

### FIELD OF THE INVENTION

The apparatus of the present invention has to do with the pre-drying and drying of successive layers of color dyes (e.g., one layer for each color dye) in the printing process of fabrics or textiles.

### BACKGROUND OF THE INVENTION

The pre-drying of color dye layers during the process of fabrics or textile printing has been traditionally done with a heat source that is permanently on top of the whole area of a table where printing processes are being performed.

The printing process is usually carried over by applying successive color dye layers on the surface o a fabric that is set over a printing table. Said successive color dye layers are applied with successive screens. Each color dye layer requires pre-drying with a heat source to avoid undesirable staining with the same non-dried dye when the next successive color dye layer is applied.

The heat source is usually situated permanently some distance from the top of the printing table. Said heat source usually has a generating heat area that corresponds to the whole area of the printing table. In addition, the heat source is always on, not only during the time of the application of successive color dye layers on a single piece of fabric being printed, but also during the whole time of printing of a batch of many single fabrics, and moreover, during the whole time that corresponds to the complete shift of the printing table operator.

To maintain always on a heat source with a generating heat area which corresponds to the whole area of the printing table during hours results in a high expenditure of energy. Furthermore, the permanent partial exposure under such heat area by the printing operator may cause chronic undesirable ill effects on said operator.

The present invention provides an apparatus that selectively and non-permanently provides heating to the top of the printing table, only when said heating is needed after successively applying each color dye layer, resulting on significant savings of energy and great lessening of heat exposure to the printing operator.

### SUMMARY OF THE INVENTION

The present invention provides an apparatus or machine to pre-dry fabric prints, wherein said machine comprises: A) a moving heat source that moves along a fixed long straight arm; B) a motor that powers the moving heat source by means of a belt; C) a control unit that commands the motor; and D) a stand for the fixed long arm with the heat source, and for the motor; wherein the heat source moves momentarily forth from a zero position along the long straight arm to a position on the top of a fabric that have been printed with a layer of fabric dye, and then the heat source moves back to the zero position.

In one aspect of the preferred embodiment of the machine of the present invention the control unit comprises an emergency stop knob switch; a two function knob switch, wherein a first function of the two-function knob switch is to activate the ignition for the heat source, and wherein a second function of the two-function knob switch is to turn on and off the machine; a knob switch to regulate the moving heat source speed; and a timing switch to regulate how long the machine is on.

In other embodiments of the machine of the present invention the control unit is a Programmable Control Logic (PLC) unit, or a programmable relay.

The control unit of the machine of the present invention responds to two sensors, wherein the first of the two sensors is on a printing table, wherein said first sensor is activated when a printing screen is off the printing table, and wherein the second of the two sensors is on the fixed long arm to indicate the zero position.

In another aspect of the preferred embodiment of the machine of the present invention the stand has at least three legs, wherein said stand's height can be adjusted, and wherein each one of the legs of the stand has wheels, and wherein said wheels have a break mechanism.

In a further aspect of the preferred embodiment of the machine of the present invention, the fixed long arm has been adapted to fit sliding mechanisms, and wherein said sliding mechanisms by means of a connection hold the heat source, wherein said connection has thermal isolating material inserted between the heat source and the fixed long arm to prevent the transmission of heat from the heat source to the fixed long arm, and wherein the thermal isolating material comprises fiberglass and asbestos.

In one more aspect of the preferred embodiment of the machine of the present invention the heat source has an extension with a bearing that is actuated upon by the belt, wherein the belt is powered forth and back by action of the motor. In other embodiments of the present invention, instead of the belt, the motor powers the movement of the heat source by means of a chain belt, a teethed belt or a cable.

In even one more aspect of preferred embodiment of the machine of the present invention, the heat source is a gas heat source, wherein said heat source has a regulator, wherein said regulator regulates the heat temperature that said gas heat source generates downwards. In another embodiment of the present invention the heat source may be an electrical heat source, wherein said electrical heat source may also have a heat temperature regulator.

Objectives and additional advantages of the present invention will become more evident in the description of the figures, the detailed description of the invention and the claims.

### BRIEF DESCRIPTION OF THE DRAWINGS

FIG. 1. shows a tridimensional illustration of one of the embodiments of the machine of the present invention.

FIG. 2. Illustrates one aspect of a preferred embodiment of the machine of the present invention, wherein the machine has a gas heat source.

### DETAILED DESCRIPTION OF THE INVENTION

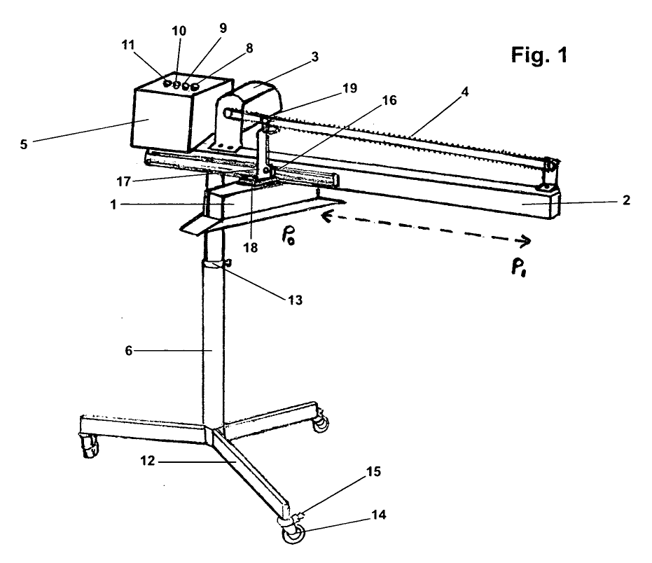

The present invention provides an apparatus or machine to pre-dry fabric prints, wherein said machine in its preferred embodiment comprises, as seen in FIG. 1: A) a moving heat source (1) that moves along a fixed long straight arm (2); B) a motor (3) that powers the moving heat source (1) by means of a belt (4); C) a control unit (5) that commands the motor (3); and D) a stand (6) for the fixed long arm (2) with the heat source (1), and for the motor (3); wherein the heat source (1) moves momentarily forth from a zero position (P₀) along the long straight arm (2) to a position (P₁) on the top of a fabric that have been printed with a layer of fabric dye, and then the heat source (1) moves back to the zero position (P₀).

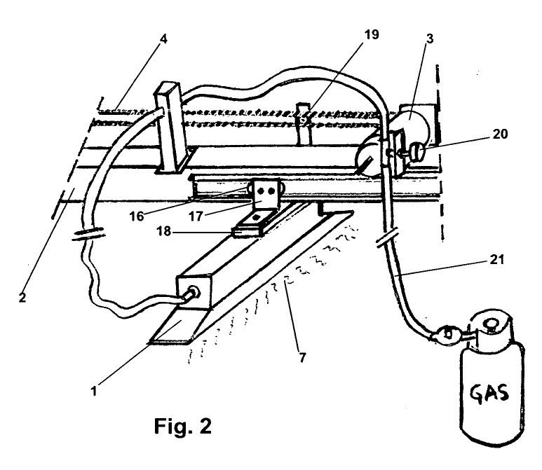

The machine of the present invention provides a way to pre-dry a color dye layer that has been applied to a fabric my means of the machine's mobile heat source (1) that generates irradiating heating in a selective efficient manner. Said heat source (1) has a heating irradiating area (7) (FIG. 2) that does not have an area as large as the area of the printing table. The heating irradiating area of the heat source (1) of the machine of the present invention may just have the width of the printing table, and be just a few inches long, several orders of magnitude less than the length of the printing table.

The geometrical heating irradiating area of the heat source (1) will provide a downwards irradiating heating swept scan on the top of the printing table by moving forth from an starting P₀ position to a P₁ position, and then moving back to the P₀ position, wherein said forth and back movement of the heat source is along the length axis of a printing table, and wherein the P1 position is at the top of the length end of the printing table, or at least a position reached after fully swept scanning the complete color dye layer that has just been applied over a fabric.

After the efficient selective pre-drying swept scan, the top of the printing table is free of heat, diminishing greatly the printing table operator's exposure to heat, allowing said operator to comfortably keep applying successive color dye layers to fabrics, and consequently, reducing also the operator's chronic effects of overexposure to heat.

In addition, by keeping on a smaller heating irradiating area (7), there is a significant saving in the amount of energy required for the heating required in the pre-drying process.

For the purpose of the present application, the P₀ position is defined as the position where the heat source is at the beginning of the fixed long arm (2) outside the top of the printing table; and the P₁ position is defined as the position of the heat source at the end of the fixed long arm which preferably corresponds to the top of the length end of the printing table, or at least to the top of the printing table after the heat source has fully swept the complete color dye layer just applied to a fabric.

In one aspect of the preferred embodiment of the machine of the present invention the control unit (5) comprises an emergency stop knob switch (8); a two function knob switch (9), wherein a first function of the two-function knob switch (9) is to activate the ignition for the heat source, and wherein a second function of the two-function knob switch (9) is to turn on and off the machine; a knob switch (10) to regulate the moving heat source (1) speed; and a timing switch (11) to regulate how long the machine is on.

In other embodiments of the machine of the present invention the control unit (5) is a Programmable Control Logic (PLC) unit, or a programmable relay.

In an aspect of the preferred embodiment of the machine of the present invention, the control unit (5) responds to two sensors, wherein the first of the two sensors is on a printing table, wherein said first sensor is activated when a printing screen is off the printing table by the print table operator, and wherein the second of the two sensors is on the fixed long arm to indicate the P₀ position. A control unit that responds to these two sensors enables the control unit to start the motor (3) powering the swept scan with the moving heating irradiating heat source (1) over the top of the printing table only when a print table operator has taken off the printing screen after said operator has just applied a color dye layer with said printing screen.

In another aspect of the preferred embodiment of the machine of the present invention, the stand (6) has at least three legs (12), wherein said stand's height can be adjusted by means of an standard adjusting mechanism (13), and wherein each one of the legs of the stand has wheels (14), and wherein said wheels have a break mechanism (15). A stand (6) with at least three legs (12) allows the machine to be moved from one fabric printing station to another fabric printing station or to other places, e.g., a storage room. The breaks (15) on each one of the wheels (14) allows the machine to be put in a temporary fixed position.

In other embodiments of the machine of the present invention, the stand's height may be permanently fixed, and said stand may have one or more legs fixed into a permanent position if said machine is part of a completely fixed fabric printing station.

In a further aspect of the preferred embodiment of the machine of the present invention, the fixed long arm (2) has been adapted to fit a sliding mechanisms (16), and wherein said sliding mechanisms (16) by means of a connection (17) hold the heat source (1), wherein said connection (17) has thermal isolating material (18) inserted between the heat source (1) and the fixed long arm (2) to prevent the transmission of heat from the heat source (1) to the fixed long arm (2), and wherein the thermal isolating material (18) comprises fiberglass and asbestos. However, in other embodiments of the present invention the thermal isolation may be made of other heat isolating materials, e.g., ceramics or heat isolating polymers.

In one more aspect of the preferred embodiment of the machine of the present invention the heat source (1) has an extension with a bearing (19) that is actuated upon by a chain belt (4), wherein the chain belt (4) is powered forth and back by action of the motor (3). In other embodiments of the present invention, instead of the chain belt (4), the motor powers the movement of the heat source by means of a plain belt, a teethed belt or a cable.

In even one more aspect of the preferred embodiment of the machine of the present invention, the heat source (1) is a gas heat source (1) (FIG. 2), wherein said heat source (1) has a regulator (20), wherein said regulator (20) maintains a basal heating irradiating temperature when the heat source is at P₀ position, and wherein said regulator allows increasing the basal heating irradiating temperature to a maximum optimal heating irradiating temperature for pre-drying only when the heat source is swept scanning on top of a printing table.

For purposes of the present invention the terms “the heat source is swept scanning on top of a printing table” mean that the heat source is moving not in direct contact, but from a distance to the top of the printing table.

The gas heat source (1) (FIG. 2) comprises a compartment where the gas from a feeding pipeline (21) is ignited into combustion with oxygen by means of standard industrial Venturi tubes, with the production of flames throughout micro-orifices in a ceramic slab situated in the lower part of the compartment, wherein said flames red-heat a metallic mesh located below the ceramic slab, wherein said metallic mesh generates irradiating heat.

The irradiating heating temperature may be changed with the regulator of the gas heat source (1), wherein the regulator may be a valve (20) that controls flow volume of gas in the feeding pipeline, therefore regulating the size of the gas flames and the red-heating of the metallic mesh, wherein said valve regulator is controlled electrically or electronically by the machine control unit (5) in accordance with the synchronization resulting from signals from the two sensors to which the control unit responds to.

The regulation of the heating irradiating temperature with increases to a maximum optimal heating irradiating temperature for pre-drying only when the heat source is swept scanning on top of a printing table, results in further efficiency and savings in the amount of gas or energy spent in the pre-drying process.

In another embodiment of the present invention the heat source of the machine of the present invention is an electrical heat source, wherein said electrical heat source may also have a heat temperature regulator. However, other forms of energy that can be transformed into heat may also be used.

While the description presents the preferred embodiments of the present invention, additional changes can be made in the form and disposition of the parts without distancing from the basic ideas and principles comprised in the claims.

1. A machine to pre-dry fabric prints, wherein said machine comprises:
A. A moving heat source that moves along a fixed long straight arm;
B. A motor that powers the moving heat source by means of a belt;
C. A control unit that commands the motor; and
D. A stand for the fixed long arm with the heat source, and for the motor;
Wherein the heat source moves momentarily forth from a zero position along the long straight arm to a position on the top of a fabric that have been printed with a layer of fabric dye, and then the heat source moves back to the zero position.

2. The machine of claim 1, wherein the control unit comprises:
A. An emergency stop knob switch;
B. A two function knob switch, wherein a first function of the knob switch is to activate the ignition for the heat source, and wherein a second function of the knob switch is to turn on and off the machine;
C. A knob switch to regulate the moving heat source speed;
D. A timing switch to regulate how long the machine is on.

3. The machine of claim 1, wherein the control unit is attached to the fixed long straight arm.

4. The machine of claim 1, wherein the control unit responds to two sensors, wherein the two sensors are a first sensor and a second sensor, wherein the first sensor is on a printing table, wherein the first sensor is activated when a printing screen is off the printing table, and wherein the second sensor is on the fixed long arm to indicate the zero position.

5. The machine of claim 1, wherein the control unit is a
Programmable Control Logic (PLC) unit.

6. The machine of claim 1, wherein the control unit is a Programmable relay.

7. The machine of claim 1, wherein the stand has at least three legs.

8. The machine of claim 7, wherein the stand's height can be adjusted, and wherein each one of the legs of the stand has wheels, and wherein said wheels have a break mechanism.

9. The machine of claim 1, wherein the fixed long arm has been adapted to fit sliding mechanisms, and wherein said sliding mechanisms by means of a connection hold the heat source.

10. The machine of claim 9, wherein the connection has thermal isolating material inserted between the heat source and the fixed long arm to prevent the transmission of heat from the heat source to the fixed long arm.

11. The machine of claim 10, wherein the thermal isolating material comprises fiberglass and asbestos.

12. The machine of claim 1, wherein the heat source has an extension with a bearing that is actuated upon by the belt.

13. The machine of claim 1, wherein the heat source has a regulator, wherein said regulator allows increasing the heat source's generating heating temperature to a maximum optimal heating temperature for pre-drying only when the heat source is swept scanning on top of a printing table.

14. The machine of claim 13, wherein the heat source generates heat downwards, and wherein said heat source is a gas heat source.

15. The machine of claim 13, wherein the heat source generates heat downwards, and wherein said heat source is an electrical heat source.

16. The machine of claim 1, wherein the motor powers the heat source by means of a chain belt.

17. The machine of claim 1, wherein the motor powers the heat source by means of a teethed belt.

18. The machine of claim 1, wherein the motor powers the heat source by means of a cable.
